(19) United States
(12) Patent Application Publication
(10) Pub. No.: US 2013/0134612 A1
(43) Pub. Date: May 30, 2013

(54) SYSTEM AND METHOD FOR FRAGMENTATION AND DISPERSAL OF A COMPRESSED GAS BODY

(71) Applicants: Cameron Phillip Lewis, Toronto (CA); David Sing-Khing Ting, LaSalle (CA); Edward Christian Janson Carrtveau, Windsor (CA); Ning Cao, Windsor (CA)

(72) Inventors: Cameron Phillip Lewis, Toronto (CA); David Sing-Khing Ting, LaSalle (CA); Edward Christian Janson Carrtveau, Windsor (CA); Ning Cao, Windsor (CA)

(21) Appl. No.: 13/304,344

(22) Filed: Nov. 24, 2011

(51) Int. Cl. B01F 3/04; F15D 1/00

(52) U.S. Cl. 261/123; 137/1

(57) ABSTRACT

A method for fragmenting a bubble of compressed gas released from a compressed gas reservoir situated at a depth under a water surface. The method comprises maintaining a grid disposed between the reservoir and the water surface to fragment the bubble into a plurality of fragmented bubble portions, the grid allowing passage therethrough of the fragmented bubble portions of the body of compressed gas generally along a travel path.

### FIELD

The present disclosure relates generally to a system and method for fragmenting and dispersing a body of compressed gas.

### BACKGROUND

Compressed Air Energy Storage (hereinafter “CAES”) systems provide one solution for effectively storing the electrical energy produced at a power grid or a renewable source during a non-peak period, then at a later time recovering and returning it to the grid upon demand. Certainly the increased emphasis on renewable energy sources, such as (but not limited to) solar energy, being inherently a discontinuous or intermittent supply source, increases the worldwide demand for affordable electrical energy storage and recovery.

CAES infrastructure may include a gas storage reservoir such as a bladder, balloon or other flexible membrane, enclosing compressed air, hydrogen or other gas. The compressed gas storage reservoir typically may be disposed at some underwater depth within a large body of water such as a lake or sea. The compressed gas reservoir receives, stores and discharges the compressed gas for deployment in the energy accumulator system. The compressed gas within the flexible reservoir is subjected to an ambient hydrostatic pressure, or higher, in its underwater disposition, the ambient hydrostatic pressure increasing proportionally with the depth at which the gas reservoir is situated.

To the extent that underwater CAES infrastructure can be safely and reliably deployed and operated, without adverse impact to its surroundings, its utility and desirability as an energy storage and recovery solution are enhanced.

### SUMMARY OF THE INVENTION

Provided is a compressed gas energy storage system having at least one compressed gas reservoir situated underwater at a depth below a water surface. The energy storage system comprises a bubble fragmentation grid disposed between the compressed gas reservoir and the water surface.

In one embodiment, the bubble fragmentation grid is sized to encompass an expected travel path of a compressed gas bubble released from the at least one compressed gas reservoir.

In another embodiment, the bubble fragmentation grid is located a distance ranging from 3 feet to 50 feet above a top of the at least one compressed gas reservoir.

In yet another embodiment, the at least one compressed gas reservoir is secured underwater by tether means, and the bubble fragmentation grid is interconnected [directly or indirectly in mechanical communication] with the tether means.

Also provided is a compressed gas energy storage system including at least one compressed gas reservoir situated underwater at a depth below a water surface. The energy storage system comprises a plurality of bubble fragmentation grids interspersed between the compressed gas reservoir and the water surface.

In an embodiment, the ones of the plurality of bubble fragmentation grids are disposed generally parallel with each other.

In another embodiment, the plurality of bubble fragmentation grids are sized to encompass an expected travel path of a compressed gas bubble released from the at least one compressed gas reservoir.

In yet another embodiment, the ones of the plurality of bubble fragmentation grids are interconnected to form a unified bubble fragmentation and dispersal unit.

In a further embodiment, the at least one compressed gas reservoir is secured underwater by tether means, and the unified bubble fragmentation and dispersal unit is interconnected with the tether means.

Also provided is a method for fragmenting a bubble of compressed gas released from a compressed gas reservoir situated at a depth under a water surface. The method comprises maintaining a grid disposed between the reservoir and the water surface to fragment the bubble into a plurality of fragmented bubble portions, the grid allowing passage therethrough of the fragmented bubble portions of the body of compressed gas to travel therethrough generally along the travel path.

In one embodiment, the grid is maintained to encompass a travel path of the released bubble of compressed gas.

In another embodiment, fragmented bubble portions are further fragmented and dispersed progressively along the travel path.

### BRIEF DESCRIPTION OF THE DRAWINGS

Embodiments will now be described by way of example only, with reference to the following drawings in which:

FIG. 1 illustrates, in a side view, an embodiment of a compressed gas energy storage system employing a compressed gas bubble fragmentation grid;

FIG. 2a illustrates, in a side view, another embodiment of a bubble fragmentation and dispersal grid;

FIG. 2b illustrates, in a top view, an embodiment of one layer of bubble fragmentation and dispersal grid; and

FIG. 3 is flowchart illustrating an embodiment of a process for fragmenting and dispersal of a compressed gas bubble released from a compressed gas reservoir.

### DETAILED DESCRIPTION

The terms “air” and “gas” are used interchangeably herein, notwithstanding literal existence of “Air” as used within the term “Compressed Air Energy Storage” (CAES). For instance, the compressed gas may comprise air, or hydrogen, or other gas, and also any combination thereof.

The terms “bubble” is used herein to refer to a body of compressed gas released from the compressed gas reservoir disposed underwater during deployment or operation of the CAES infrastructure. The terms “body” and “bubble” are interchangeably used herein.

A catastrophic failure of the underwater-situated compressed gas reservoir could potentially cause uncontrolled release of a compressed gas bubble, which, propelled by attendant buoyancy forces, rapidly rise from the underwater source of release in a travel path directly towards the water surface, accelerating in speed as it increases in size and volume during ascent. This consequently may create an undesirable, possibly dangerous impact on any persons or shipping traffic at (or near) the water surface proximately above the source of the compressed gas bubble release.

It is contemplated that release of the compressed gas bubble as described herein may be caused by either an uncontrolled or catastrophic failure, such as a rupture of the gas reservoir or balloon, or by a more controlled, intentional release, such as related to maintenance operations during use and deployment of an underwater CAES system. Regardless of the nature of origination of a released bubble, there is a need to ensure the safety of, and co-existence with, existing water surface recreational usage, small- and large-scale shipping traffic and other similar activities performed in the proximity of deployed CAES systems.

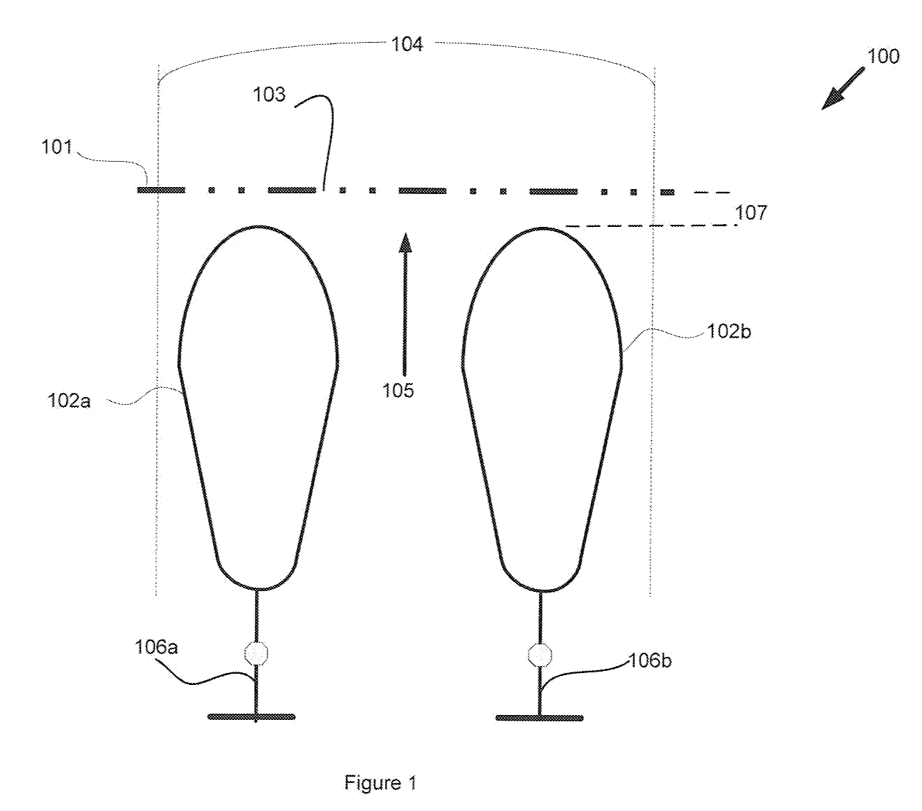

Referring now more particularly to the accompanying figures, FIG. 1 illustrates, in a side view, an embodiment of CAES system 100 employing compressed gas bubble fragmentation grid 101. The grid 101 is generally planar, and arranged at height 107 typically about 3 to 80 feet above the top of compressed gas reservoir 102a, 102b.

Still with reference to FIG. 1, grid 101 may be sized to encompass an expected travel path 104 of a compressed gas bubble released from the compressed gas reservoir 102a, 102b along travel direction 105.

Compressed gas reservoir 102a, 102b may be anchored underwater such as by tether means 106a, 106b, such as a tether line or even be rigidly anchor to the sea floor/lake bed. Bubble fragmentation grid 101 may be structured to be either directly connected, or be interconnected indirectly, with the tether means, or with any other part of the attendant CAES infrastructure.

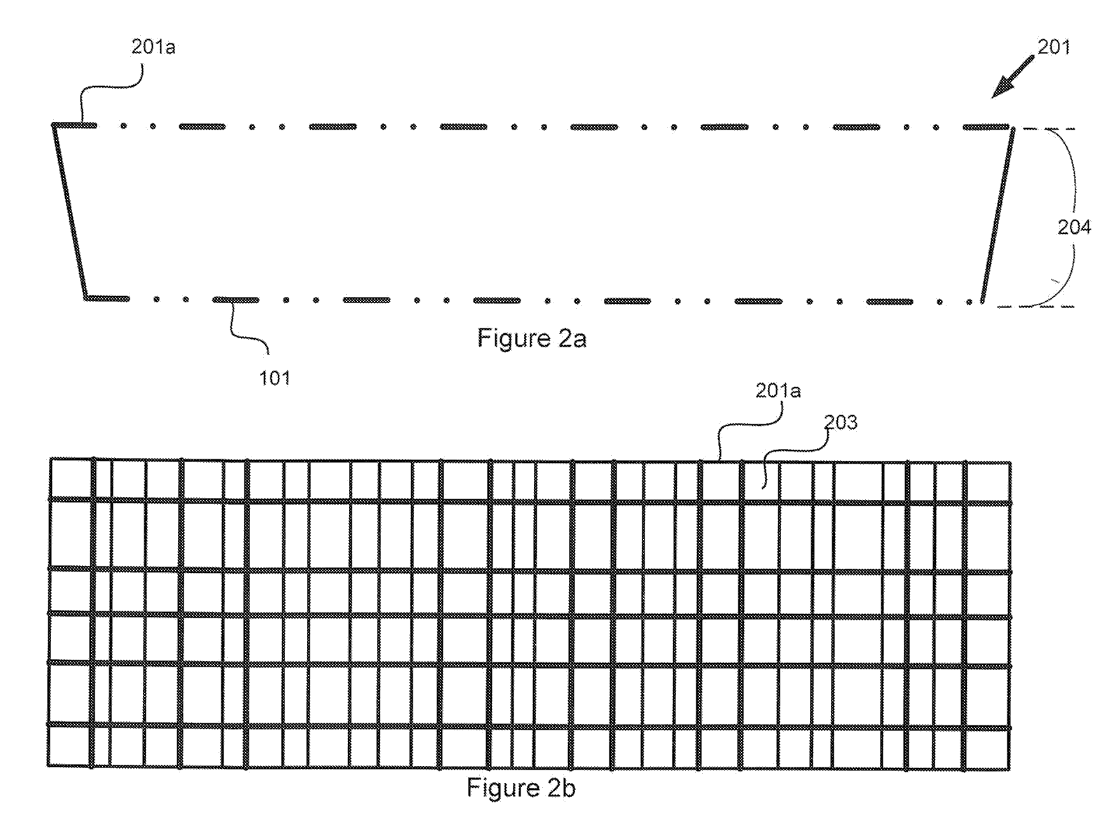

FIG. 2a illustrates, in a side view, another embodiment of a bubble fragmentation grid of FIG. 1, intended to provide further-pronounced bubble fragmentation and dispersal. A progressive bubble fragmentation grid 201a, similar in construction to grid 101, may be situated between bubble fragmentation grid 101 and the water surface. Progressive bubble fragmentation grid 201a not only further fragments the bubble fragments created from passage of compressed gas bubbles through grid 101, but prevents adjacent bubble fragments created from coalescing again, thereby promoting dispersion of the bubble fragments. It is contemplated that any number of such progressively-arranged bubble fragmentation grids may be interspersed, at either regularly- or irregularly-spaced intervals 204, between the first bubble fragmentation grid 101 of FIG. 1 and the water surface. Such a plurality of bubble fragmentation grids may be sized to encompass expected travel path 104 of a compressed gas bubble released from compressed gas reservoir 102a, 102b, and may be disposed generally parallel with each other, or may be aligned at other angles relative to each other, to introduce turbulence and randomness for enhanced bubble fragmentation and dispersion.

FIG. 2b illustrates a top view of the bubble fragmentation and dispersal grid 201a. Grid 201a from a top view may comprise a mesh- or grid-like arrangement of regularly- or irregularly-spaced, criss-crossing material. Overall, typically less than 20% of the aggregate planar surface area of the grid is solid material, with the remaining at least 80% of the aggregate planar surface area being open spacings or gaps 203, although other arrangements of solid material/spacing proportions are contemplated. The solid material of grid 201a fragments a compressed gas bubble, released from compressed gas reservoir 101a, 101b that impinge thereon when ascending generally along upward travel direction 105 shown in FIG. 1, while open spacings 203 enable passage therethrough of the fragmented bubble portions. Grid 201a may be constructed of any material, including metal, composite, polymer, fabric, or any combination thereof.

The sizes of the criss-crossing grid material of grids 101, 201a may range from 1 to 10 inches typically, but may be chosen empirically, with a goal of being sufficiently wide to inhibit coalescence of adjacent ones of fragmented bubble portions passing through grid spacings 103, to the extent possible. It will be apparent that upward travel direction 105 is prescribed by the influence of attendant buoyancy forces acting upon the released compressed gas bubble, and constitutes generally a straight-line path from the source of bubble release at gas reservoir 102a, 102b to the water surface (not shown) directly overhead.

In one embodiment, the plurality of progressively-arranged bubble fragmentation grids 101 and 201a may be interconnected to form unified bubble fragmentation and dispersal unit 201.

In another embodiment, unified bubble fragmentation and dispersal unit 201 may be structured to either be directly connected, or be interconnected indirectly, with the tether means, or with any other part of the attendant CAES infrastructure.

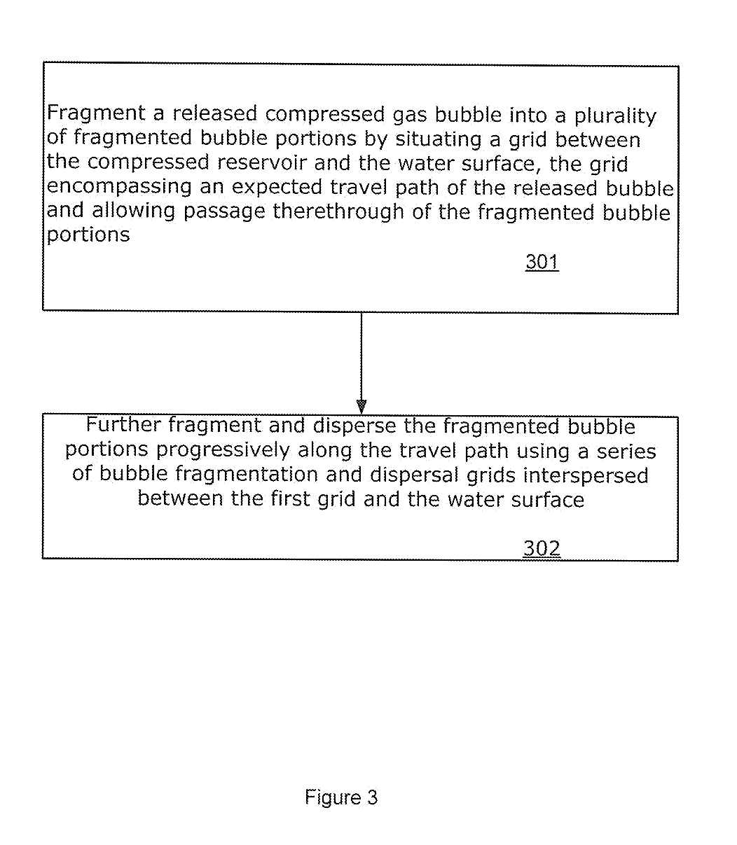

FIG. 3 is a flowchart illustrating an embodiment of a process for fragmenting and dispersal of a compressed gas bubble released from underwater compressed gas reservoir 102a, 102b of compressed gas energy storage system 100.

At step 301, fragment a released compressed gas bubble into a plurality of fragmented bubble portions by situating grid 101 between compressed gas reservoir 102a, 102b and the water surface, the grid 101 encompassing expected travel path 104 of the released bubble and allowing passage therethrough of the fragmented bubble portions.

At step 302, further fragment and disperse the fragmented bubble portions emanating from grid 101 progressively along travel path 104 using a series of grids 201 interspersed between grid 101 and the water surface.

Varying modifications of the compressed gas bubble fragmentation apparatus and method will be apparent to those skilled in the art, without departing from the scope of the invention as defined by the appended claims.

What is claimed is:

1. A compressed gas energy storage system having at least one compressed gas reservoir situated underwater at a depth below a water surface, the energy storage system comprising:
a bubble fragmentation grid disposed between the compressed gas reservoir and the water surface.

2. The system of claim 1 wherein the bubble fragmentation grid is sized to encompass an expected travel path of a compressed gas bubble released from the at least one compressed gas reservoir.

3. The system of claim 1 wherein the bubble fragmentation grid is located a distance ranging from 3 feet to 80 feet above a top of the at least one compressed gas reservoir.

4. The system of claim 1 wherein the at least one compressed gas reservoir is secured underwater by tether means, and the bubble fragmentation grid is interconnected [directly or indirectly in mechanical communication] with the tether means.

5. A compressed gas energy storage system including at least one compressed gas reservoir situated underwater at a depth below a water surface, the energy storage system comprising:
a plurality of bubble fragmentation grids interspersed between the compressed gas reservoir and the water surface.

6. The system of claim 5 wherein ones of the plurality of bubble fragmentation grids are disposed generally parallel with each other.

7. The system of claim 5 wherein the plurality of bubble fragmentation grids are sized to encompass an expected travel path of a compressed gas bubble released from the at least one compressed gas reservoir.

8. The system of claim 5 wherein ones of the plurality of bubble fragmentation grids are interconnected to form a unified bubble fragmentation and dispersal unit.

9. The system of claim 8 wherein the at least one compressed gas reservoir is secured underwater by tether means, and the unified bubble fragmentation and dispersal unit is interconnected with the tether means.

10. A method for fragmenting a bubble of compressed gas released from a compressed gas reservoir situated at a depth under a water surface, the method comprising:
maintaining a grid disposed between the reservoir and the water surface to fragment the bubble into a plurality of fragmented bubble portions, the grid allowing passage therethrough of the fragmented bubble portions of the body of compressed gas to travel therethrough generally along the travel path.

11. The method of claim 10 wherein the grid is maintained to encompass a travel path of the released bubble of compressed gas.

12. The method of claim 10 comprising further fragmenting and dispersing the fragmented portions progressively along the travel path.
